(19) United States
(12) Patent Application Publication
(10) Pub. No.: US 2017/0055176 A1
(43) Pub. Date: Feb. 23, 2017

(54) PDCP TRANSMITTING ENTITY, SECONDARY BASE STATION, USER EQUIPMENT AND ASSOCIATED METHODS

(71) Applicants: Fangying XIAO, Shanghai (CN); SHARP KABUSHIKI KAISHA, Sakai City, Osaka (JP)

(72) Inventors: Fangying XIAO, Shanghai (CN); Renmao LIU, Shanghai (CN)

(73) Assignee: SHARP KABUSHIKI KAISHA, Sakai City, Osaka (JP)

(21) Appl. No.: 15/307,661

(22) PCT Filed: Apr. 30, 2015
(86) PCT No.: PCT/CN2015/077948

§ 371 Date: Oct. 28, 2016

(30) Foreign Application Priority Data
Apr. 30, 2014 (CN) 201410181233.6

(51) Int. Cl. H04W 28/02; H04L 12/26; H04L 5/00; H04L 29/06

(52) U.S. Cl. CPC H04W 28/0268; H04L 69/28; H04L 43/0829; H04L 5/0055

(57) ABSTRACT

The present disclosure provides a mechanism allowing a PDCP transmitting entity to move a transmitting window even after a packet loss over an Xn interface. According to an embodiment, a timer is provided in the PDCP transmitting entity and is started when it is determined that a packet loss may occur. The transmitting window can be moved when the timer expires, regardless of whether a PDCP PDU corresponding to a lower limit of the transmitting window has been acknowledged to be successfully transmitted or not. According to a further embodiment, a PDCP receiving entity maintains a receiving window and a t-Reordering timer is used to assist the PDCP transmitting entity to move the transmitting window. In this way, even if a packet loss occurs over the Xn interface, the transmitting window can be moved to continue transmitting subsequent PDCP PDUs.

### TECHNICAL FIELD

The present disclosure relates to mobile communications, and more particularly, to a Packet Data Convergence Protocol (PDCP) transmitting entity, a secondary base station, a PDCP receiving entity, a method in a PDCP transmitting entity for transmitting PDCP Protocol Data Units (PDUs), a method in a secondary base station for reporting successful transmission of PDCP PDUs to a master base station, and a method in a PDCP receiving entity for acknowledging successful reception of PDCP PDUs, capable of synchronizing movement of a transmitting window at the PDCP transmitting entity and movement of a receiving window at the PDCP receiving entity.

### BACKGROUND

The user plane protocol stack at Layer 2 in the 3^{rd} Generation Partnership Project (3GPP) Long Term Evolution (LTE) system consists of three sub-layers. They are, from high to low: Packet Data Convergence Protocol (PDCP) layer, Radio Link Control (RLC) layer and Media Access Control (MAC) layer. At a transmitting entity, traffic is provided to a particular layer by receiving Service Data Units (SDUs) from a higher layer and Protocol Data Units (PDUs) are outputted to a lower layer. For example, the RLC layer receives packets from the PDCP layer. These packets are PDCP PDUs for the PDCP layer, but also RLC SDUs for the RLC layer. An inverse process occurs at the receiving side. That is, each layer sends SDUs to a higher layer, which receives them as PDUs. The PDCP entity that receives PDCP PDUs is referred to as a PDCP Rx and the RLC entity that receives RLC PDUs is referred to as RLC Rx. Each PDCP SDU is identified by a PDCP sequence number (SN). Each PDCP SDU has the same SN as its corresponding PDCP PDU and RLC SDU. Each RLC PDU is identified by an RLC SN. The PDCP SNs and the RLC SNs can be reused in a round robin manner. When the PDCP SN reaches its maximum value, the next PDCP SN is numbered as the minimum value, with a corresponding Hyper Frame Number (HFN) incremented by 1. The PDCP SN and the HFN are combined into COUNT that uniquely identifies a PDCP SDU.

In 3GPP LTE Release 11, each radio bearer has a PDCP entity and an RLC entity. Each Base Station (BS), or NodeB or evolved NodeB (eNB), and each User Equipment (UE) has a MAC entity. Here, the UE can be a user terminal, a user node, a mobile terminal or a tablet computer. The 3GPP LTE Release 12, which is currently being developed, involves standardization for dual connectivity enabled UE, Master eNB (MeNB) and Secondary eNB (SeNB). A MeNB maintains Radio Resource Management (RRM) measurement configurations for a UE, and requests a SeNB for additional resources for the UE based on a received measurement report, a traffic condition or a bearer type. Upon receiving the request from the MeNB, the SeNB either configures a serving cell for the UE, or rejects the request due to lack of sufficient resources.

Based on different schemes for bearer split and the user plane protocol stack, in 3GPP TSG-RAN2 Meeting 83bis, two user plane architectures, 1A and 3C, have been determined as standardization options for the dual connectivity deployment. This is disclosed in 3GPP TR 36.842, which is incorporated herein by reference in its entirety. As shown in FIG. 1, the option 3C has the following features: (1) the MeNB communicates with a Serving Gateway (S-GW) via an S1-U interface; (2) the bearer split occurs in the MeNB; and (3) for a split bearer, its corresponding RLC entity exists in both the MeNB and the SeNB. In the option 3C, the RLC entity at the SeNB interacts with a higher layer (i.e., a PDCP entity at the MeNB) via an Xn interface (which includes an X2 interface). Accordingly, a dual connectivity enabled UE provides one PDCP entity and two RLC entities for a split bearer. The PDCP entity corresponds to the PDCP entity in the MeNB. One of the two RLC entities corresponds to the RLC entity in the MeNB and the other one corresponds to the RLC entity in the SeNB.

In 3GPP LTE Release 11, since each PDCP Rx corresponds to only one RLC Rx, a reordering function in the RLC Rx ensures that the PDCP Rx can receive PDCP PDUs from the RLC layer in order. However, in the dual connectivity deployment with a split bearer, one PDCP Rx corresponds to two RLC Rxs and thus the PDCP PDUs the PDCP Rx receives from the two RLC Rxs are out of order. Hence, the PDCP Rx needs to reorder the PDCP PDUs from the two RLC Rxs. In 3GPP TSG RAN WG2 Meeting #85, it has been proposed that the PDCP reordering function will use a reordering scheme based on a t-Reordering timer, similar to the scheme used in UM RLC. This reordering scheme is disclosed in 3GPP TR36.300, which is incorporated herein by reference in its entirety. The basic concept of this scheme is as follows. The PDCP Rx maintains a receiving window, also referred to as reordering window, having a size equal to a half of the PDCP PDU SN space. The PDCP Rx receives PDCP PDUs from two RLC Rxs and discards any PDCP PDU as received if its SN is not within the receiving window. When a PDCP PDU is received out of order but its SN is within the receiving window, it can be stored in a reordering buffer and a t-Reordering timer can be started, waiting for the arrival of the missing PDCP PDUs. When the missing PDCP PDUs are received, the PDCP PDUs that have been received in order will be delivered to the higher layer. On the other hand, when the t-Reordering timer expires, the PDCP PDUs that have arrived in order, other than those PDCP SDUs corresponding to the t-Reordering timer that are not arrived in order, will be delivered to the higher layer. At the same time, a lower limit of the receiving window is set to the maximum SN among the PDCP SDUs that have been delivered to the higher layer plus 1. In order to ensure the synchronization between the HFN at the PDCP Tx and the HFN at the PDCP Rx, accordingly, it is necessary to ensure that the difference between the maximum and minimum SNs among the PDCP PDUs that have been transmitted but have not be acknowledged is smaller than a half of the SN space. Further, the PDCP Tx can only transmit PDCP PDUs having SNs ranging from the minimum SN among the PDCP PDUs that have been transmitted but have not be acknowledged to the minimum SN plus a half of the SN space and minus 1. For a downlink in the dual connectivity mode, the RLC Tx in the SeNB needs to transmit an indication message indicating successful transmission of the PDCP PDUs to the PDCP Tx in the MeNB via the Xn interface, such that the PDCP Tx can transmit more PDCP PDUs. In addition, when the PDCP Tx transmits a PDCP PDU to the RLC Tx in the SeNB via the Xn interface, the data might be lost. The RLC Tx in the SeNB cannot send an acknowledgement message to the PDCP Tx since it has not received the data. In this case, after transmitting the lost PDCP PDU and an allowable number of subsequent PDCP PDUs (having SNs larger than the SN of the lost PDCP PDU and smaller than the SN of the lost PDCP PDU plus a half of the SN space), the PDCP Tx cannot transmit any further PDCP PDUs, resulting in a degraded transmission delay and reliability over a radio link.

### SUMMARY

In order to solve the above problems, the present disclosure provides a mechanism allowing the PDCP transmitting entity to move the transmitting window even after a packet loss over the Xn interface and continue transmitting subsequent PDCP PDUs.

According to an aspect of the present disclosure, a method in a Packet Data Convergence Protocol (PDCP) transmitting entity for transmitting PDCP Protocol Data Units (PDUs) is provided. The method comprises: upon receiving an indication message indicating that a PDCP PDU has been successfully transmitted: moving a transmitting window based on a sequence number of the successfully transmitted PDCP PDU as indicated in the indication message, such that a lower limit of the transmitting window indicates a minimum sequence number among PDCP PDUs that have not been acknowledged to be successfully transmitted; determining whether there is any PDCP PDU having a sequence number larger than the lower limit of the transmitting window that has been acknowledged to be successfully transmitted; and starting a timer when there is any PDCP PDU having a sequence number larger than the lower limit of the transmitting window that has been acknowledged to be successfully transmitted.

In one or more embodiments, the transmitting window is moved when the timer expires.

In one or more embodiments, when the timer expires, the lower limit of the transmitting window is set to a second smallest sequence number among the PDCP PDUs that have not been acknowledged to be successfully transmitted, and it is determined whether there is any PDCP PDU having a sequence number larger than the lower limit of the transmitting window that has been acknowledged to be successfully transmitted. When there is any PDCP PDU having a sequence number larger than the lower limit of the transmitting window that has been acknowledged to be successfully transmitted, the timer is started.

In one or more embodiments, the timer that is running is removed when it is determined that there is no PDCP PDU having a sequence number larger than the lower limit of the transmitting window that has been acknowledged to be successfully transmitted.

In one or more embodiments, before the timer is started, it is determined whether a PDCP PDU corresponding to the lower limit of the transmitting window has been transmitted to a secondary base station. If so, the timer is started; or otherwise no operation is applied to the timer.

According to another aspect of the present disclosure, a method in a Packet Data Convergence Protocol (PDCP) transmitting entity for transmitting PDCP Protocol Data Units (PDUs) is provided. The method comprises: receiving from a PDCP receiving entity a receiver indication message indicating a minimum sequence number among PDCP PDUs that have not been received by the PDCP receiving entity; comparing a lower limit of a transmitting window with the sequence number of PDCP PDU as indicated in the receiver indication message; and moving, when the lower limit of the transmitting window is smaller than or equal to the sequence number of PDCP PDU as indicated in the receiver indication message, the lower limit of the transmitting window to a minimum sequence number among PDCP PDUs that have sequence numbers larger than the sequence number indicated in the receiver indication message and have not been acknowledged.

According to another aspect of the present disclosure, a method in a Packet Data Convergence Protocol (PDCP) receiving entity for acknowledging successful reception of PDCP Protocol Data Units (PDUs) is provided. The method comprises: maintaining a receiving window having a lower limit indicating a minimum sequence number among PDCP PDUs that have not been received; starting a timer when a PDCP PDU having a sequence number larger than the lower limit of the receiving window and within the receiving window is received; moving the receiving window and removing the timer when a PDCP PDU corresponding to the lower limit of the receiving window is received; and moving the receiving window when the timer expires, and transmitting an indication message to a master base station transmitting the PDCP PDU to indicate to the master base station to move the transmitting window, wherein the message contains the minimum sequence number among the PDCP PDUs that have not been received.

In one or more embodiments, when the timer expires, the lower limit of the transmitting window is set to a second smallest sequence number among the PDCP PDUs that have not been received.

According to another aspect of the present disclosure, a method in a secondary base station for acknowledging successful transmission of Packet Data Convergence Protocol (PDCP) Protocol Data Units (PDUs) is provided. The method comprises: receiving from a master base station PDCP PDUs to be transmitted, each PDCP PDU having a sequence number; and transmitting, after successfully transmitting at least one PDCP PDU, to the master base station a message indicating that the PDCP PDU has been successfully transmitted, the message indicating the sequence number of the successfully transmitted PDCP PDU.

According to another aspect of the present disclosure, a Packet Data Convergence Protocol (PDCP) transmitting entity is provided. The PDCP transmitting entity comprises: a timer; a receiver configured to receive an indication message indicating that a Packet Data Convergence Protocol (PDCP) Protocol Data Unit (PDU) has been successfully transmitted; a transmitting window moving unit configured to move a transmitting window based on a sequence number of the successfully transmitted PDCP PDU as indicated in the indication message; and a timer controller configured to determine whether there is any PDCP PDU having a sequence number larger than the lower limit of the transmitting window that has been acknowledged to be successfully transmitted, and start the timer when there is any PDCP PDU having a sequence number larger than the lower limit of the transmitting window that has been acknowledged to be successfully transmitted.

According to another aspect of the present disclosure, a Packet Data Convergence Protocol (PDCP) transmitting entity is provided. The PDCP transmitting entity comprises: a receiver configured to receive from a PDCP receiving entity a receiver indication message indicating a minimum sequence number among PDCP Protocol Data Units (PDUs) that have not been received by the PDCP receiving entity; and a transmitting window moving unit configured to compare a lower limit of a transmitting window maintained at the PDCP transmitting entity with the sequence number of PDCP PDU as indicated in the receiver indication message, and, when the lower limit of the transmitting window is smaller than or equal to the sequence number of PDCP PDU as indicated in the receiver indication message, move the lower limit of the transmitting window to a minimum sequence number among PDCP PDUs that have sequence numbers larger than the sequence number indicated in the receiver indication message and have not been acknowledged.

According to another aspect of the present disclosure, a User Equipment (UE) is provided. The UE comprises: a memory configured to maintain a receiving window having a lower limit indicating a minimum sequence number among Packet Data Convergence Protocol (PDCP) Protocol Data Units (PDUs) that have not been received; a receiver configured to receive at least one PDCP PDU; a timer; a timer controller configured to start the timer when a PDCP PDU having a sequence number larger than the lower limit of the receiving window and within the receiving window is received by the receiver, and remove the timer when a PDCP PDU corresponding to the lower limit of the receiving window is received by the receiver; a receiving window moving unit configured to move the receiving window when a PDCP PDU corresponding to the lower limit of the receiving window is received by the receiver or when the timer expires; and a transmitter configured to transmit an indication message to a master base station from which the PDCP PDU is received to indicate to the master base station to move the transmitting window when the timer expires, wherein the message contains the minimum sequence number among the at least one PDCP PDU that have not been received.

According to another aspect of the present disclosure, a secondary base station cooperating with a master base station is provided. The secondary base station comprises: a receiver configured to receive from the master base station Packet Data Convergence Protocol (PDCP) Protocol Data Units (PDUs) to be transmitted, each PDCP PDU having a sequence number; and a transmitter configured to transmit, after successfully transmitting at least one PDCP PDU, to the master base station a message indicating that the PDCP PDU has been successfully transmitted, the message indicating the sequence number of the successfully transmitted PDCP PDU.

With one or more embodiments of the present disclosure, a timer is provided in the PDCP transmitting entity, such that a transmitting window can be moved even if a packet loss occurs over an Xn interface, i.e., the PDCP Tx can transmit further data, without degrading the transmission delay and reliability over a radio link. According to other embodiments of the present disclosure, a PDCP receiving entity maintains a receiving window and a t-Reordering timer is used to assist the PDCP transmitting entity to move the transmitting window. In this way, even if a packet loss occurs over the Xn interface, the transmitting window can be moved and the synchronization between the HFN at the PDCP Tx and the HFN at the PDCP Rx can be maintained.

### BRIEF DESCRIPTION OF THE DRAWINGS

The above and other objects, features and advantages will be more apparent from the following description of embodiments with reference to the figures, in which:

FIG. 1 is a schematic diagram showing an option 3C for dual connectivity deployment as specified in 3GPP TR 36.842;

FIG. 2 is a flowchart illustrating a method in a PDCP transmitting entity for transmitting PDCP PDUs according to one or more embodiments of the present disclosure;

FIG. 3 is another flowchart illustrating another method in a PDCP transmitting entity for transmitting PDCP PDUs according to one or more embodiments of the present disclosure;

FIG. 4 is a flowchart illustrating a method for operating a t-Transmitting timer according to one or more embodiments of the present disclosure;

FIG. 5 is another flowchart illustrating another method in a PDCP transmitting entity for transmitting PDCP PDUs according to one or more embodiments of the present disclosure;

FIG. 6 is another flowchart illustrating another method in a PDCP transmitting entity for transmitting PDCP PDUs according to one or more embodiments of the present disclosure;

FIG. 7 is a flowchart illustrating a method in a secondary base station (SeNB) for transmitting an indication message indicating successful transmission of PDCP PDU to a master base station (MeNB) according to one or more embodiments of the present disclosure;

FIG. 8 is a schematic diagram showing an example of a bitmap;

FIG. 9 is a flowchart illustrating a method in a secondary base station (SeNB) for transmitting an indication message indicating successful transmission of PDCP PDU to a master base station (MeNB) according to one or more embodiments of the present disclosure;

FIG. 10 is a flowchart illustrating a method in a PDCP receiving entity for acknowledging successful reception of PDCP PDUs according to one or more embodiments of the present disclosure;

FIG. 11 is another flowchart illustrating another method in a PDCP transmitting entity for transmitting PDCP PDUs according to one or more embodiments of the present disclosure;

FIG. 12 is a block diagram showing a structure of a PDCP transmitting entity according to one or more embodiments of the present disclosure;

FIG. 13 is a block diagram showing a structure of a secondary base station according to one or more embodiments of the present disclosure;

FIG. 14 is a block diagram showing a structure of a UE according to one or more embodiments of the present disclosure; and

FIG. 15 is block diagram showing a structure of a PDCP transmitting entity according to one or more embodiments of the present disclosure.

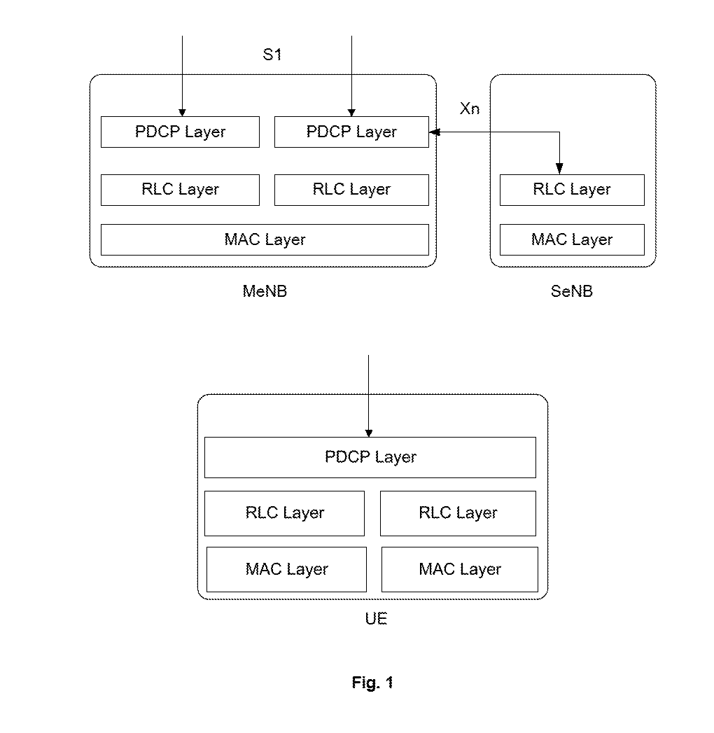

### DETAILED DESCRIPTION

The principles and implementations of the present disclosure will become more apparent from the following description of the embodiments taken in conjunction with the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE Release 12 mobile communication system and its subsequent evolutions. Herein, it is to be noted that the present invention is not limited to the application exemplified in the embodiments. Rather, it is applicable to other communication systems, such as the future 5G cellular communication system.

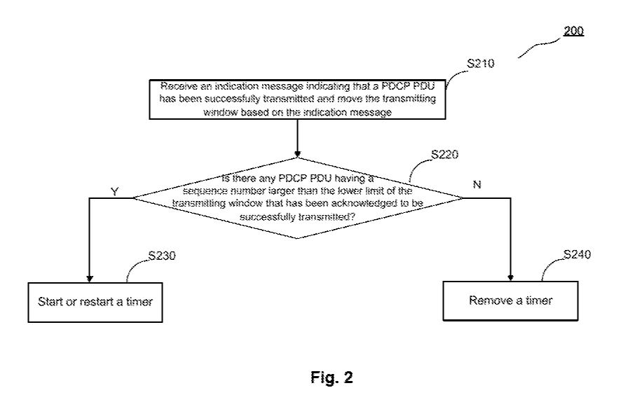

FIG. 2 is a flowchart illustrating a method 200 in a PDCP transmitting entity for transmitting PDCP PDUs according to one or more embodiments of the present disclosure. For the purpose of illustration, in one or more embodiments of the present disclosure, the current PDCP PDU transmitting space will be described as a transmitting window similar to the one used in the RLC entity. However, the present disclosure is not limited to the transmitting window for describing the PDCP PDUs currently allowable to be transmitted.

In the method shown in FIG. 2, a transmitting window is maintained at the PDCP transmitting entity. The transmitting window has a lower limit corresponding to a minimum sequence number among PDCP PDUs that have not been acknowledged to be successfully transmitted. The PDCP PDUs currently allowable to be transmitted are defined by the lower limit and an upper limit of the transmitting window, which defines a maximum sequence number among PDCP PDUs allowable to be transmitted plus 1. The size of the transmitting window is a half of the space for PDCP PDU sequence numbers. The movement of the transmitting window depends on acknowledgement messages indicating successful transmissions as received by two RLC entities located at MeNB and SeNB, respectively. It is to be noted that, in the context of the present disclosure, a comparison between sequence numbers refers to a comparison between respective COUNT values corresponding to the sequence numbers, and an addition/subtraction calculation of a sequence number refers to an addition/subtraction calculation of a COUNT value corresponding to the sequence number.

First, at step S210, the PDCP transmitting entity receives an indication message indicating that a PDCP PDU has been successfully transmitted. The PDCP transmitting entity moves the transmitting window based on the indication message, such that the lower limit of the transmitting window indicates a minimum sequence number among PDCP PDUs that have not been acknowledged to be successfully transmitted.

Next, at step S220, it is determined whether there is any PDCP PDU having a sequence number larger than the lower limit of the transmitting window that has been acknowledged to be successfully transmitted.

If it is determined at step S220 that there is any PDCP PDU having a sequence number larger than the lower limit of the transmitting window that has been acknowledged to be successfully transmitted, then at step S230, a timer is started; otherwise at step S240, the timer that is running, if any, is removed.

According to one or more embodiments of the present disclosure, a timer is introduced and is started when a packet loss may occur. In this way, by setting an expiration value of the timer appropriately and operating properly when the timer expires, the transmitting window can be moved when the packet loss occurs.

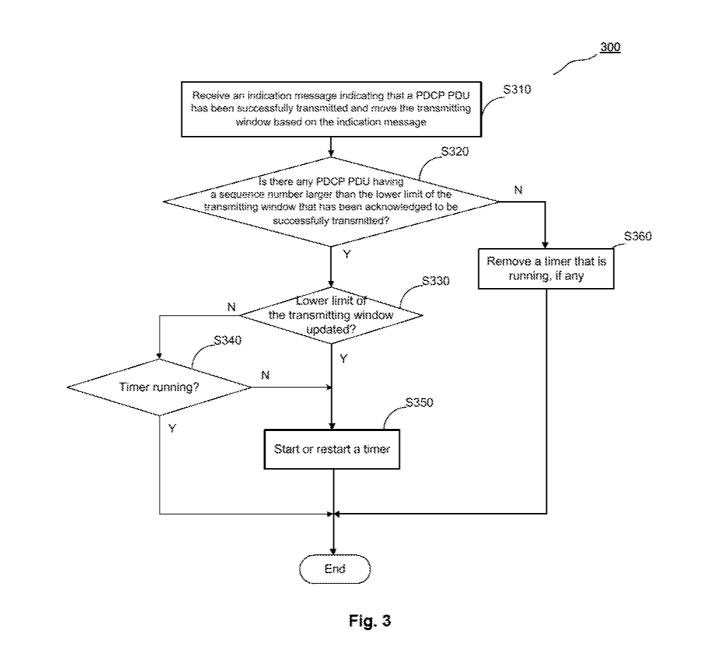

FIG. 3 is another flowchart illustrating another method 300 in a PDCP transmitting entity for transmitting PDCP PDUs according to one or more embodiments of the present disclosure.

First, the PDCP transmitting entity maintains a constant t-Transmittingtimer, which is the value of a t-Transmitting timer. According to one or more embodiments, the value of the t-Transmitting timer at the PDCP transmitting entity depends on a value of t-Reordering timer at a PDCP receiving entity. For example, the t-Transmittingtimer can be set to a value equal to or slightly smaller than the value of the t-Reordering timer. In the embodiments of the present disclosure, a comparison between sequence numbers refers to a comparison between respective COUNT values corresponding to the sequence numbers.

As shown in FIG. 3, at step S310, the PDCP transmitting entity receives from a lower layer entity an indication message indicating that a PDCP PDCU has been successfully transmitted and moves a transmitting window based on the indication message. If the indication message indicates that a PDCP PDU corresponding to a current lower limit of the transmitting window has been successfully transmitted, the PDCP transmitting entity updates the lower limit of the transmitting window with a new minimum sequence number among PDCP PDUs that have not been acknowledged to be successfully transmitted.

At step S320, the PDCP transmitting entity determines whether there is any PDCP PDU having a sequence number larger than the lower limit of the transmitting window that has been acknowledged to be successfully transmitted. If so, the method proceeds with step S330; or otherwise the method proceeds with step S360.

At step S330, the PDCP transmitting entity operates depending on whether the lower limit of the transmitting window has been updated at step S310. If the lower limit of the transmitting window has been updated, the method proceeds with step S350; or otherwise the method proceeds with step S340.

At step S340, the PDCP transmitting entity determines whether there is a t-Transmitting timer that is running. If not, the method proceeds with step S350.

At step S350, the PDCP transmitting entity starts or restarts the t-Transmitting timer. That is, if the t-Transmitting timer is running, it is restarted; or otherwise it is started.

At step S360, the PDCP transmitting entity determines whether the t-Transmitting timer is running. If so, the running timer is removed.

According to one or more embodiments of the present disclosure, a timer is introduced and is started when a packet loss may occur. In this way, by setting an expiration value of the timer appropriately and operating properly when the timer expires, the transmitting window can be moved when the packet loss occurs.

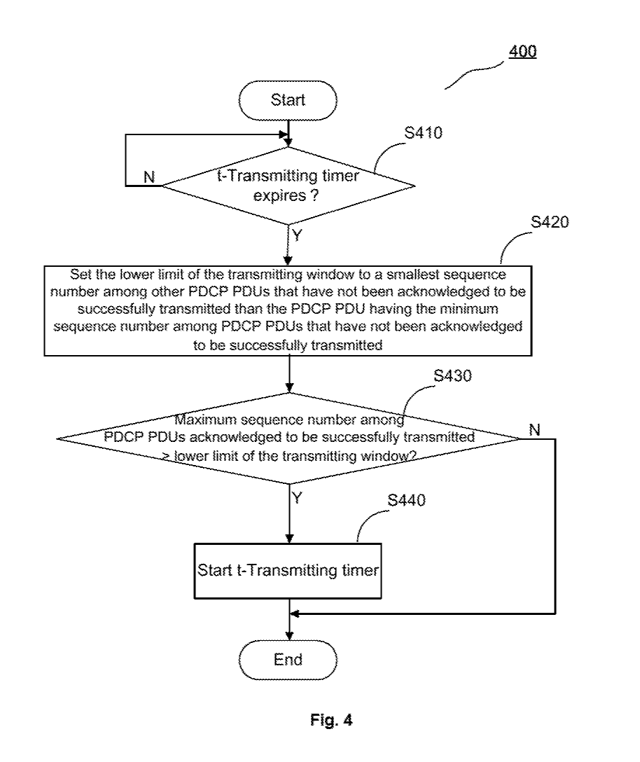

FIG. 4 is a flowchart illustrating a method 400 for operating a t-Transmitting timer according to one or more embodiments of the present disclosure.

After the method starts, at step S410, it is determined whether the t-Transmitting timer has expired.

If so, the method proceeds with step S420, in which a transmitting window is moved. According to one or more embodiments, as shown in the step S420, the lower limit of the transmitting window is set to a second smallest sequence number among the PDCP PDUs that have not been acknowledged to be successfully transmitted, i.e., the smallest sequence number among other PDCP PDUs that have not been acknowledged to be successfully transmitted than the one corresponding to the t-Transmitting timer.

Then, at step S430, a maximum sequence number among successfully transmitted PDCP PDUs is compared with a sequence number corresponding to the lower limit of the transmitting window.

If the maximum sequence number among the successfully transmitted PDCP PDUs is larger than the sequence number corresponding to the lower limit of the transmitting window, then at step S440, the t-Transmitting timer is restarted again; or otherwise the t-Transmitting timer will not be set any more and the method ends.

In this embodiment, when the t-Transmitting timer expires, the lower limit of the transmitting window is set to the smallest sequence number among other PDCP PDUs that have not been acknowledged to be successfully transmitted than the one corresponding to the t-Transmitting timer. At this time, if the maximum sequence number among the successfully transmitted PDCP PDUs is larger than the updated lower limit of the transmitting window, i.e., if there is any potential packet loss, the t-Transmitting timer is restarted. In this embodiment, even if a packet loss may occur, the transmitting window can be moved when the timer expires. Hence, it is possible to prevent the transmitting window from being stuck due to packet loss.

In the LTE Release 12, the dual connectivity deployment is only applicable to the RLC acknowledge mode. In the RLC acknowledge mode, the RLC entity at the MeNB can always ensure all PDCP PDUs from the higher layer to be transmitted properly. Hence, in order to avoid starting the t-Transmitting timer frequently, the PDCP transmitting entity can only start the t-Transmitting timer for PDCP PDUs transmitted by the SeNB. That is, the t-Transmitting timer is started when the PDCP PDU having the smallest sequence number among the PDCP PDUs that have not be acknowledged (the lower limit of the transmitting window) is transmitted by the SeNB and its sequence number is smaller than the maximum sequence number among the successfully transmitted PDCP PDUs.

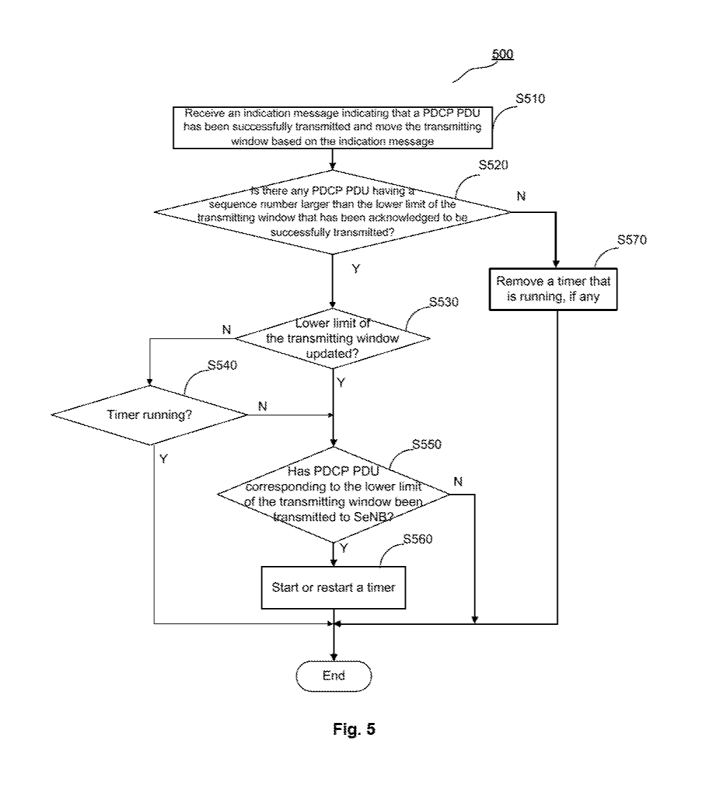

FIG. 5 is another flowchart illustrating another method 500 in a PDCP transmitting entity for transmitting PDCP PDUs according to one or more embodiments of the present disclosure.

The steps S510, S520, S530 and S540 are the same as the steps S310, S320, S330 and S340 in the method 300 as shown in FIG. 3 and the description thereof will be omitted here.

At step S550, the PDCP transmitting entity determines whether the PDCP PDU corresponding to the lower limit of the transmitting window is transmitted to a PDCP receiving entity at a UE by the SeNB. If so, the method proceeds with step S560; or otherwise the method ends.

The steps S560 and S570 are the same as the steps S350 and S360 in the method 300 as shown in FIG. 3 and the description thereof will be omitted here.

For example, it is assumed here that the transmitting window at the PDCP transmitting entity has a size of 6 and PDCP PDUs having sequence numbers of 0-5 have been transmitted but have not be acknowledged to be successfully transmitted. Here, the PDCP PDUs having sequence numbers of 0 and 3 are transmitted by the RLC entity at the MeNB and the PDCP PDUs having sequence numbers of 1, 2, 4 and 5 are transmitted by the RLC entity at the SeNB. After a time period, the PDCP transmitting entity receives from the SeNB an indication message indicating that the PDCP PDUs having sequence numbers of 2, 4 and 5 have been successfully transmitted. In this case, the minimum sequence number among the PDCP PDUs that have not been acknowledged to be successfully transmitted is 0 and the maximum sequence number among the successfully transmitted PDCP PDUs is 5. According to the steps S520, S530, S540, S550 and S560, the PDCP transmitting entity starts the t-Transmitting timer. Then, after another time period, the PDCP transmitting entity receives from the RLC entity at the MeNB an indication message indicating that the PDCP PDU having the sequence number of 0 has been successfully transmitted. According to the step S510, the PDCP transmitting entity updates the lower limit of the transmitting window to 1. According to the step S520, S530, S550 and S560, the t-Transmitting timer is restarted. If the t-Transmitting timer expires, according to the step S420, the PDCP transmitting entity updates the lower limit of the transmitting window to the second smallest sequence number, 3, among the PDCP PDUs that have not been acknowledged. Then, according to the steps S430 and S440, the t-Transmitting timer is restarted.

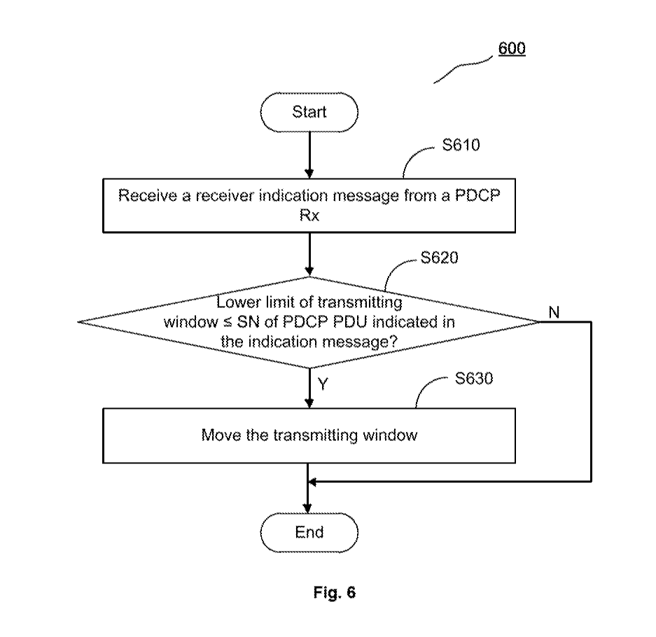

FIG. 6 is another flowchart illustrating another method 600 in a PDCP transmitting entity for transmitting PDCP PDUs according to one or more embodiments of the present disclosure.

As shown in FIG. 6, at step S610, the t-Reordering timer at the PDCP receiving entity expires and the PDCP receiving entity moves its receiving window accordingly. The PDCP receiving entity transmits to the corresponding PDCP transmitting entity an indication message carrying the sequence number of PDCP PDU corresponding to the t-Reordering timer started at the PDCP receiving entity. For example, it is assumed that the PDCP receiving entity receives PDCP PDUs having sequence numbers of 0, 1, 3, 4 and 5, respectively, and maps the PDCP PDUs having the sequence numbers of 0 and 1 into a PDCP SDU for delivering to the higher layer. Since the PDCP PDUs having the sequence numbers of 3, 4 and 5 are not received in order, these PDCP PDUs are stored locally and a t-Reordering timer is started. When the t-Reordering timer expires, the PDCP receiving entity transmits to the PDCP transmitting entity an indication message containing a sequence number of 2.

At step S620, upon receiving the indication message, the PDCP transmitting entity compares the lower limit of its transmitting window with the sequence number of PDCP PDU as indicated in the indication message. When the lower limit of the transmitting window is smaller than or equal to the sequence number of PDCP PDU as carried in the indication message, at step S630, the moving window is moved such that the lower limit of the transmitting window is set to a minimum sequence number among PDCP PDUs that have sequence numbers larger than the sequence number carried in the indication message and have not been acknowledged. That is, the transmitting window is received to a position corresponding to the minimum sequence number among PDCP PDUs that have sequence numbers larger than the sequence number carried in the indication message and have not been acknowledged.

According to this embodiment, the PDCP receiving entity maintains a receiving window and the t-Reordering timer is used to assist the PDCP transmitting entity to move the transmitting window. In this way, the synchronization between the HFN at the PDCP transmitting entity and the HFN at the PDCP receiving entity can be maintained.

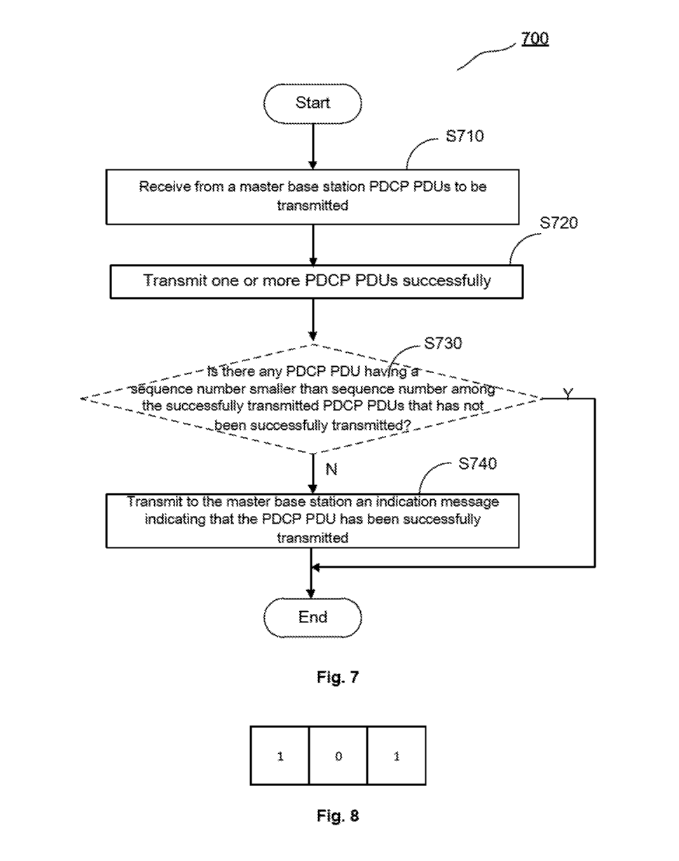

In one or more embodiments shown in FIGS. 3-5, after successfully transmitting PDCP PDUs from the higher layer PDCP transmitting entity at the MeNB, the SeNB transmits to the PDCP transmitting entity at the MeNB an indication message indicating that the PDCP PDUs have been successfully transmitted, such that the MeNB can move the transmitting window accordingly. FIG. 7 is a flowchart illustrating a method 700 in a secondary base station (SeNB) for transmitting an indication message indicating successful transmission of PDCP PDU to a master base station (MeNB) according to one or more embodiments of the present disclosure

As shown in FIG. 7, at step S710, the SeNB receives from the MeNB PDCP PDUs to be transmitted.

At step S720, the SeNB transmits at least one PDCP PDU successfully.

Then, at step S740, the SeNB transmits to the MeNB an indication message indicating that the PDCP PDU has been successfully transmitted.

In the flowchart shown in FIG. 7, before the SeNB transmits the indication message to the MeNB at step S740, there can be a step S730 in which the SeNB determines whether there is any PDCP PDU having a sequence number smaller than the maximum sequence number among the successfully transmitted PDCP PDUs that has not been successfully transmitted. If not, the method proceeds with step S740; or otherwise the method ends.

At step S740, an indication message indicating that the PDCP PDU has been successfully transmitted is transmitted to the MeNB.

The SeNB can transmit an indication message after successfully transmitting a plurality of PDCP PDUs in order, rather than transmitting an indication message for each successfully transmitted PDCP PDU, so as to avoid generating and transmitting indication messages at the SeNB, thereby reducing signaling overhead over the Xn interface.

According to one or more embodiments, the indication message can contain sequence numbers of all successfully transmitted PDCP PDUs. According to one or more other embodiments, the indication message can contain: a minimum sequence number among successfully transmitted PDCU PDUs; and a bitmap and a bitmap length indicator. The bitmap is generated based on the sequence numbers of the successfully transmitted PDCP PDUs. For example, when the SeNB receives from the MeNB PDCP PDUs having sequence numbers of 1, 2, 4 and 5, respectively, and the PDCP PDUs having the sequence numbers of 1, 2 and 4 have been successfully transmitted, the SeNB can transmit to the MeNB an indication message indicating that those PDCP PDUs have been successfully transmitted. According to one or more embodiments, the indication message carries the minimum sequence number, 1, among the successfully transmitted PDCU PDUs, a bitmap length, 3, and a bitmap as shown in FIG. 8. In the bitmap shown in FIG. 8, each bit in the bitmap represents whether its corresponding PDCP PDU has been successfully transmitted and the sequence number of the PDCP PDU corresponding to each bit in the bitmap is a value obtained by adding the minimum sequence number among the successfully transmitted PDCU PDUs and a position of the bit in the bitmap. To indicate the PDCP PDUs having the sequence numbers of 1 (the minimum sequence number among the successfully transmitted PDCP PDUs) to 4 (the maximum sequence number among the successfully transmitted PDCP PDUs), the bitmap length if 4-1=3 (there are four PDCP PDUs having the sequence number of 1-4, among which the PDCP PDU having the sequence number of 1 has been indicated separately and does not need to be indicated in the bitmap). As an example, in the bitmap shown in FIG. 8, each position having a value of 1 represents that its corresponding PDCP PDU has been successfully transmitted, and each position having a value of 0 represents that its corresponding PDCP PDU has not been received. For example, the first bit, from left to right, in the bitmap corresponds to the PDCP PDU having the sequence number of 2 and its value of 1 represents that the PDCP PDU having the sequence number of 2 has been successfully transmitted. The second bit corresponds to the PDCP PDU having the sequence number of 3 and its value is 0 since the PDCP PDU having the sequence number of 3 has not been transmitted by the SeNB. The third bit corresponds to the PDCP PDU having the sequence number of 4 and its value of 1 represents that the PDCP PDU having the sequence number of 4 has been successfully transmitted.

In most cases, the PDCP PDUs transmitted from the MeNB in order will arrive at the SeNB in order and will be transmitted by the SeNB in order. In the embodiment shown in FIG. 7, the SeNB will generate indication message indicating successful transmissions of PDCP PDUs frequently, resulting in high signaling overhead over the Xn interface.

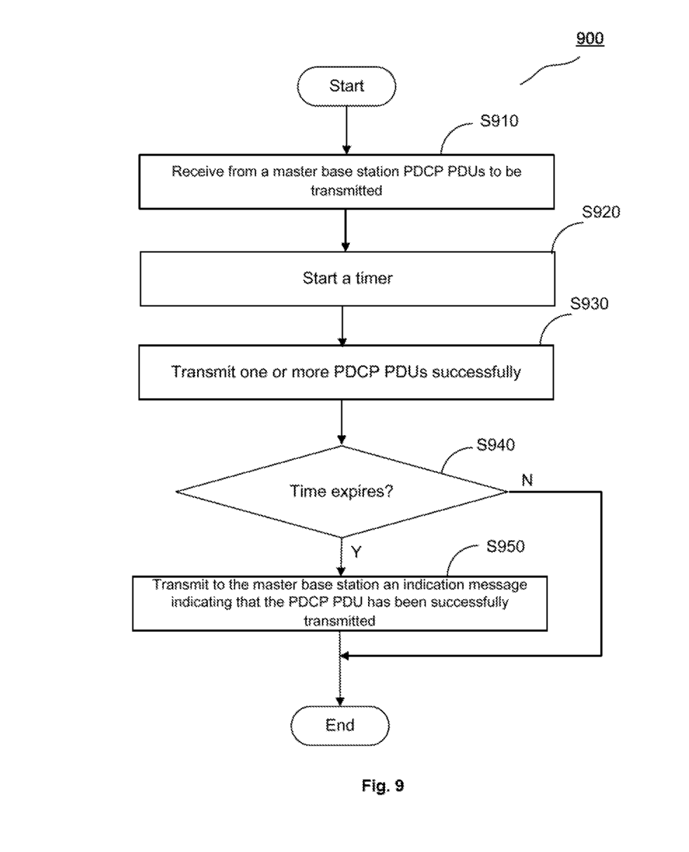

FIG. 9 is a flowchart illustrating a method 900 in a secondary base station (SeNB) for transmitting an indication message indicating successful transmission of PDCP PDU to a master base station (MeNB) according to one or more embodiments of the present disclosure.

At step S910, the SeNB receives from the MeNB PDCP PDUs to be transmitted.

At step S920, a timer is started.

At step S930, the SeNB transmits at least one PDCP PDU successfully.

At step S940, it is determined whether the timer has expired. If so, the method proceeds with step S950; or otherwise the method ends.

At step S950, an indication message indicating that the PDCP PDU has been successfully transmitted is transmitted to the MeNB.

According to this embodiment, a timer, referred to as indication_timer, is added to control the time interval at which the indication messages indicating successful transmissions of PDCP PDUs are transmitted. The indication message indicating that the PDCP PDU has been successfully transmitted is transmitted to the MeNB only when the timer expires. According to one or more embodiments, the indication message indicates all successfully transmitted PDCP PDUs. According to one or more other embodiments, the indication message only indicates less than all successfully transmitted PDCP PDUs. The indicated PDCP PDUs satisfy the condition that each PDCP PDU from the MeNB and having a sequence number smaller than those of the indicated PDCP PDUs has been successfully transmitted. For example, it is assumed that the SeNB receives PDCP PDUs having sequence numbers of 1, 3, 4, 5 and 7, respectively, from the MeNB and the timer, indication_timer, expires after the PDCP PDUs having the sequence numbers of 1, 3, 4 and 7 have been successfully transmitted. The SeNB can transmit to the MeNB an indication message indicating all the successfully transmitted PDCP PDUs, i.e., indicating that the PDCP PDUs having the sequence numbers of 1, 3, 4 and 7 have been successfully transmitted. Alternatively, the SeNB can transmit to the MeNB an indication message indicating less than all the successfully transmitted PDCP PDUs, i.e., indicating that the PDCP PDUs having the sequence numbers of 1, 3 and 4 have been successfully transmitted (since the PDCP PDU having the sequence number of 5 has not been transmitted successfully). The value of the timer, indication_timer, needs to be set depending on factors such as the size of the transmitting window at the MeNB, the rate at which the MeNB transmits PDCP PDUs to two lower layer entities, and the like.

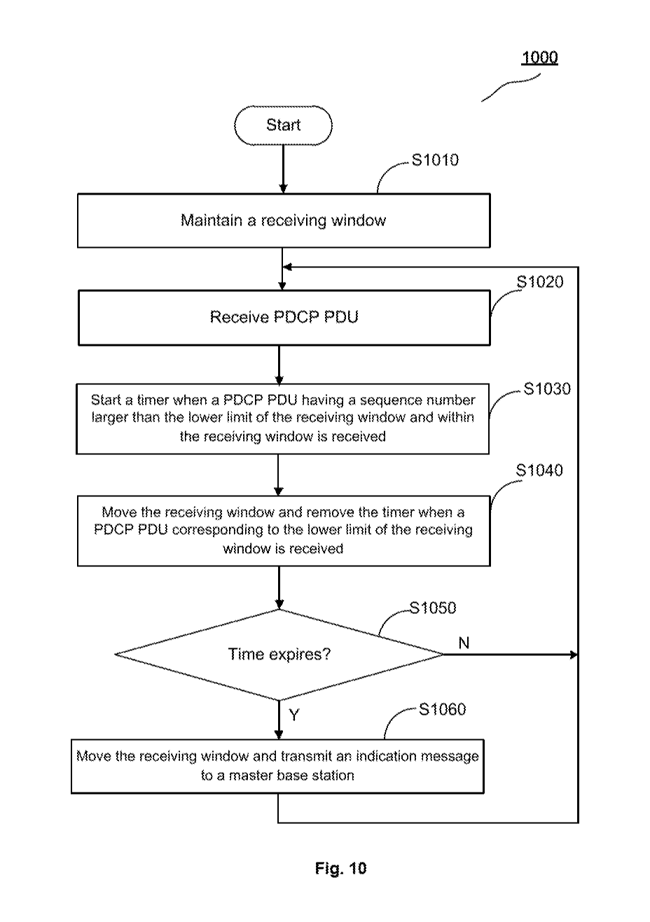

In the embodiment described in connection with FIG. 6, the PDCP receiving entity maintains a receiving window and a t-Reordering timer is used to assist the PDCP transmitting entity to move the transmitting window i.e., for transmitting subsequent PDCP PDUs. FIG. 10 is a flowchart illustrating a method 1000 in a PDCP receiving entity for acknowledging successful reception of PDCP PDUs according to one or more embodiments of the present disclosure.

As shown, at step S1010, the PDCP receiving entity maintains a receiving window having a lower limit indicating a minimum sequence number among PDCP PDUs that have not been received.

At step S1020, at least one PDCP PDU is received.

At step S1030, a timer is started when a PDCP PDU having a sequence number larger than the lower limit of the receiving window and within the receiving window is received.

At step S1040, the receiving window is moved and the timer is removed when a PDCP PDU corresponding to the lower limit of the receiving window is received.

At step S1050, it is determined whether the timer has expired. If so, at step S1060, the receiving window is moved and an indication message is transmitted to a master base station transmitting the PDCP PDU to indicate to the master base station to move the transmitting window. The message contains the minimum sequence number among the PDCP PDUs that have not been received. Otherwise, the method returns to the step S1020, waiting to receive a PDCP PDU.

According to one or more embodiments, when the timer expires, the lower limit of the receiving window is set to a second smallest sequence number among the PDCP PDUs that have not been received.

According to one or more embodiments, the timer is a t-Reordering timer.

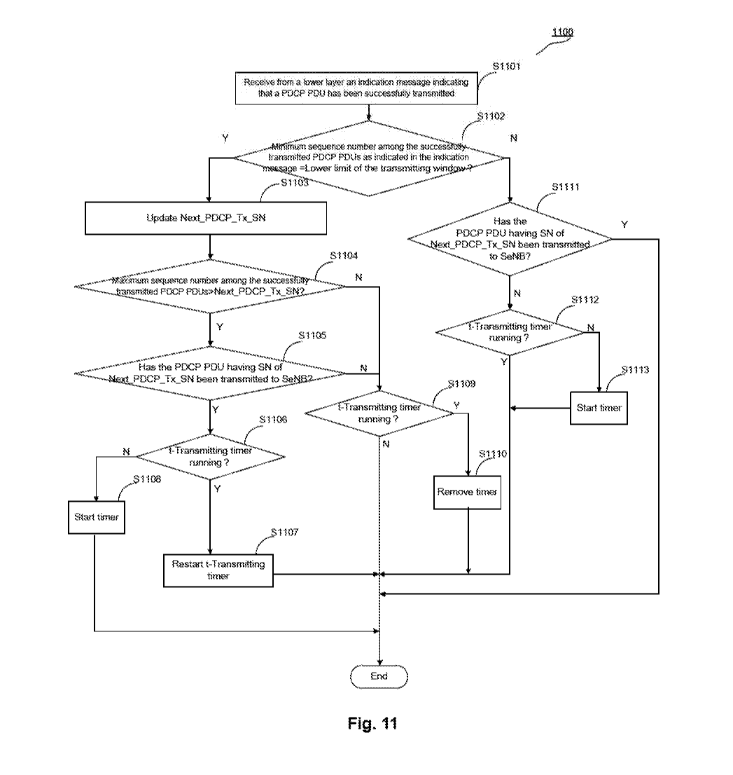

FIG. 11 is another flowchart illustrating another method 1100 in a PDCP transmitting entity for transmitting PDCP PDUs according to one or more embodiments of the present disclosure.

First of all, the PDCP transmitting entity maintains a constant t-Transmittingtimer and variables Next_PDCP_Tx_SN and Max_PDCP_ACK_SN. Here, Next_PDCP_Tx_SN denotes a minimum sequence number among PDCP PDUs that have not been acknowledged to be successfully transmitted, i.e., a lower limit of a transmitting window, and Max_PDCP_ACK_SN denotes a maximum sequence number among PDCP PDUs that have been currently acknowledged to be successfully transmitted.

At step S1101, the PDCP transmitting entity receives from a lower layer entity an indication message indicating that a PDCP PDU has been successfully transmitted, and updates Max_PDCP_ACK_SN to the maximum sequence number among the successfully transmitted PDCP PDUs.

At step S1102, the PDCP transmitting entity determines whether the minimum sequence number among the successfully transmitted PDCP PDUs as indicated in the indication message is the lower limit of the transmitting window. If so, the method proceeds with step S1103; or otherwise the method proceeds with step S1111.

At step S1103, the PDCP transmitting entity updates Next_PDCP_Tx_SN to a new minimum sequence number among PDCP PDUs that have not been acknowledged to be successfully transmitted.

At step S1104, the PDCP transmitting entity determines whether the maximum sequence number among the successfully transmitted PDCP PDUs, i.e., the variable Max_PDCP_ACK_SN is larger than Next_PDCP_Tx_SN. If so, the method proceeds with step S1105; or otherwise the method proceeds with step S1109.

At step S1105, the PDCP transmitting entity determines whether the PDCP PDU having the sequence number of Next_PDCP_Tx_SN has been transmitted by the SeNB to the PDCP receiving entity at the UE. If so, the method proceeds with step S1106; or otherwise the method proceeds with step S1109.

At step S1106, it is determined whether there is any timer that is running. If so, the method proceeds with step S1107; or otherwise the method proceeds with step S1108.

At step S1107, the t-Transmitting timer is restarted.

At step S1108, the t-Transmitting timer is started.

At step S1109, it is determined whether there is a t-Transmitting timer that is running. If so, the method proceeds with step S1110; or otherwise the method ends.

At step S1110, the t-Transmitting timer that is running is removed.

At step S1111, it is determined whether the PDCP PDU having the sequence number of Next_PDCP_Tx_SN has been transmitted to the SeNB. If so, the method ends; or otherwise the method proceeds with step S1112.

At step S1112, it is determined whether there is a t-Transmitting timer that is running. If so, the method ends; or otherwise the method proceeds with step S1113.

At step S1113, the t-Transmitting timer is started.

According to this embodiment, a variable is maintained for determination as to whether a packet loss occurs.

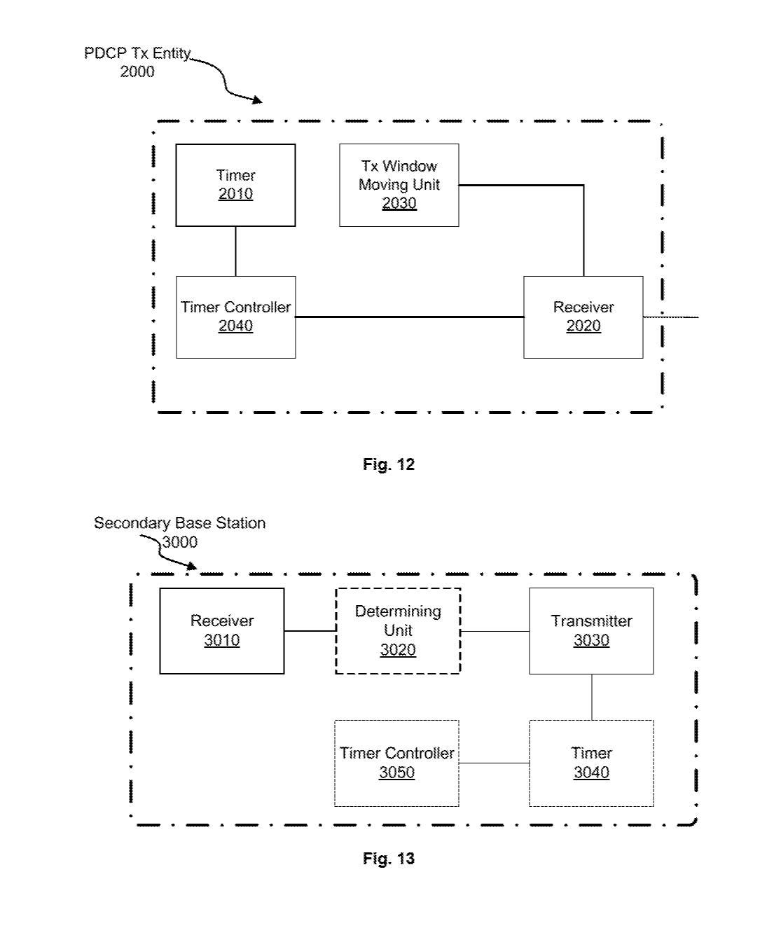

Correspondingly to the methods according to one or more embodiments of the present disclosure, the present disclosure further provides a PDCP transmitting entity 2000. FIG. 12 is a block diagram showing a structure of a PDCP transmitting entity 2000 according to one or more embodiments of the present disclosure.

As shown, the PDCP transmitting entity 2000 includes a timer 2010, a receiver 2020, a transmitting window moving unit 2030 and a timer controller 2040.

The receiver 2020 is configured to receive an indication message indicating that a PDCP PDU has been successfully transmitted.

The transmitting window moving unit 2030 is configured to move a transmitting window based on a sequence number of the successfully transmitted PDCP PDU as indicated in the indication message.

The timer controller 2040 is configured to determine whether there is any PDCP PDU having a sequence number larger than the lower limit of the transmitting window that has been acknowledged to be successfully transmitted, and start the timer 2010 when there is any PDCP PDU having a sequence number larger than the lower limit of the transmitting window that has been acknowledged to be successfully transmitted.

In one or more embodiments, the transmitting window moving unit 2030 is further configured to move the transmitting window when the timer 2010 expires.

In one or more embodiments, the transmitting window moving unit 2030 is further configured to set the lower limit of the transmitting window to a second smallest sequence number among the PDCP PDUs that have not been acknowledged to be successfully transmitted, when the timer 2010 expires.

In one or more embodiments, the timer controller 2030 is configured to: determine whether the transmitting window has been moved: start the timer 2010 when the timer has not been started, or restarting the timer when the timer 2010 has been started, if the transmitting window has been moved; or start the timer 2010 when the timer 2010 has not been started, if the transmitting window has not been moved.

In one or more embodiments, the timer controller 2030 is configured to remove the timer 2010 that is running when it is determined that there is no PDCP PDU having a sequence number larger than the lower limit of the transmitting window that has been acknowledged to be successfully transmitted.

In one or more embodiments, the timer controller 2030 is configured to determine whether a PDCP PDU corresponding to the lower limit of the transmitting window has been transmitted to a secondary base station. If so, the timer is started; or otherwise no operation is applied to the timer.

In one or more embodiments, the timer 2010 has an expiration value that is set based on a t-Reordering timer of a PDCP receiving entity that receives PDCP PDUs from the PDCP transmitting entity.

In one or more embodiments, the indication message contains sequence numbers of all successfully transmitted PDCP PDUs.

In one or more embodiments, the indication message contains: a minimum sequence number among successfully transmitted PDCU PDUs; and a bitmap and a bitmap length indicator. Each bit in the bitmap represents whether its corresponding PDCP PDU has been successfully transmitted. The sequence number of the PDCP PDU corresponding to each bit in the bitmap is a value obtained by adding the minimum sequence number among the successfully transmitted PDCU PDUs and a position of the bit in the bitmap.

Correspondingly to the methods according to one or more embodiments of the present disclosure, the present disclosure further provides a secondary base station 3000. FIG. 13 is a block diagram showing a structure of a secondary base station 3000 according to one or more embodiments of the present disclosure.

As shown, the secondary base station 3000 includes a receiver 3010 and a transmitter 3030.

The receiver 3010 is configured to receive from the master base station PDCP PDUs to be transmitted. Each PDCP PDU has a sequence number.

The transmitter 3030 is configured to transmit, after successfully transmitting at least one PDCP PDU, to the master base station a message indicating that the PDCP PDU has been successfully transmitted. The message indicates the sequence number of the successfully transmitted PDCP PDU.

As shown in FIG. 13, the secondary base station 3000 can further include a determining unit 3020 configured to determine, after at least one PDCP PDU has been successfully transmitted, whether there is any PDCP PDU having a sequence number smaller than the sequence number of the successfully transmitted PDCP PDU that has not been successfully transmitted.

The transmitter 3030 is configured to transmit, when it is determined by the determining unit 3020 that there is no PDCP PDU having a sequence number smaller than the sequence number of the successfully transmitted PDCP PDU that has not been successfully transmitted, to the master base station the message indicating that the PDCP PDU has been successfully transmitted.

As shown in FIG. 13, the secondary base station 3000 can further include a timer 3040 and a timer controller 3050. The timer controller 3050 is configured to start the timer 3030 when the PDCP PDUs to be transmitted are received from the master base station. In one or more embodiments, the transmitter 3030 is further configured to transmit, after successfully transmitting at least one PDCP PDU, to the master base station the message indicating that the PDCP PDU has been successfully transmitted when the timer 3040 expires.

In one or more embodiments, the message contains sequence numbers of all successfully transmitted PDCP PDUs.

In one or more embodiments, the message contains: a minimum sequence number among successfully transmitted PDCU PDUs; and a bitmap and a bitmap length indicator. Each bit in the bitmap represents whether its corresponding PDCP PDU has been successfully transmitted. The sequence number of the PDCP PDU corresponding to each bit in the bitmap is a value obtained by adding the minimum sequence number among the successfully transmitted PDCU PDUs and a position of the bit in the bitmap.

In one or more embodiments, the message only indicates less than all successfully transmitted PDCP PDUs. Each PDCP PDU from the master base station and having a sequence number smaller than those of the indicated PDCP PDUs has been successfully transmitted.

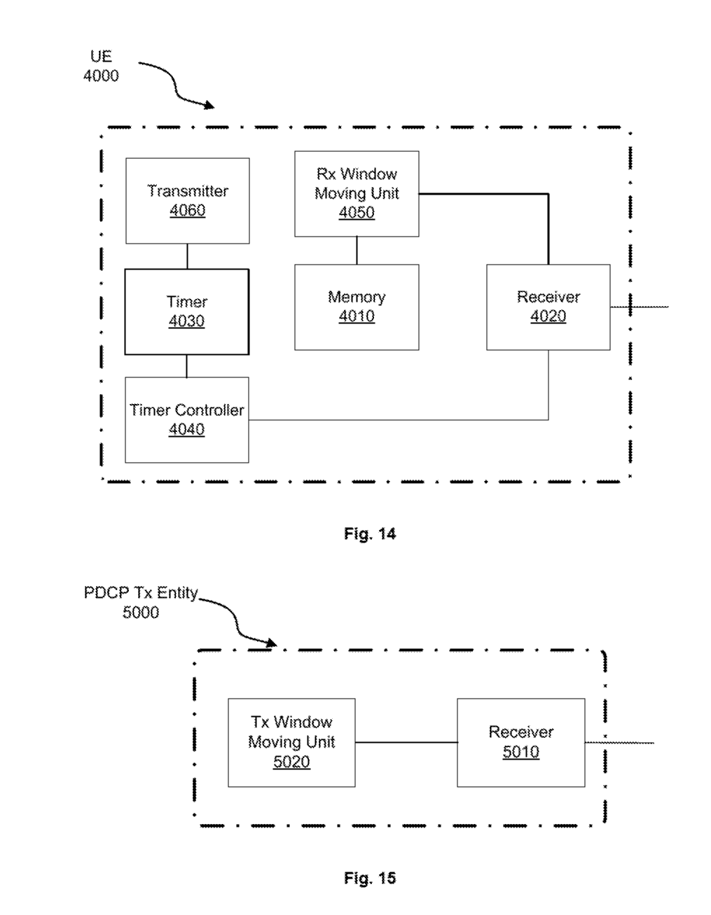

Correspondingly to the methods according to one or more embodiments of the present disclosure, the present disclosure further provides a UE 4000. FIG. 14 is a block diagram showing a structure of a UE 4000 according to one or more embodiments of the present disclosure.

As shown, the UE 4000 includes a memory 4010, a receiver 4020, a timer 4030, a timer controller 4040, a receiving window moving unit 4050 and a transmitter 4060.

The memory 4010 is configured to maintain a receiving window having a lower limit indicating a minimum sequence number among PDCP PDUs that have not been received.

The receiver 4020 is configured to receive at least one PDCP PDU.

The timer controller 4040 is configured to start the timer 4030 when a PDCP PDU having a sequence number larger than the lower limit of the receiving window and within the receiving window is received by the receiver, and remove the timer 4030 when a PDCP PDU corresponding to the lower limit of the receiving window is received by the receiver.

The receiving window moving unit 4050 is configured to move the receiving window when a PDCP PDU corresponding to the lower limit of the receiving window is received by the receiver 4020 or when the timer 4030 expires.

The transmitter 4060 is configured to transmit an indication message to a master base station from which the PDCP PDU is received to indicate to the master base station to move the transmitting window when the timer 4030 expires. The message contains the minimum sequence number among the at least one PDCP PDU that have not been received.

In one or more embodiments, the receiving window moving unit 4050 is configured to set the lower limit of the receiving window to a second smallest sequence number among the PDCP PDUs that have not been received, when the timer 4030 expires.

Correspondingly to the methods according to one or more embodiments of the present disclosure, the present disclosure further provides a PDCP transmitting entity 5000. FIG. 15 is block diagram showing a structure of a PDCP transmitting entity 5000 according to one or more embodiments of the present disclosure.

As shown, the PDCP transmitting entity 5000 includes a receiver 5010 and a transmitting window moving unit 5020.

The receiver 5010 is configured to receive from a PDCP receiving entity a receiver indication message indicating a minimum sequence number among PDCP PDUs that have not been received by the PDCP receiving entity.

The transmitting window moving unit 5020 is configured to compare a lower limit of a transmitting window maintained at the PDCP transmitting entity with the sequence number of PDCP PDU as indicated in the receiver indication message, and, when the lower limit of the transmitting window is smaller than or equal to the sequence number of PDCP PDU as indicated in the receiver indication message, move the lower limit of the transmitting window to a minimum sequence number among PDCP PDUs that have sequence numbers larger than the sequence number indicated in the receiver indication message and have not been acknowledged.

With one or more embodiments of the present disclosure, a timer is provided in the PDCP transmitting entity, such that a transmitting window can be moved even if a packet loss occurs over an Xn interface, i.e., the PDCP Tx can transmit further data, without degrading the transmission delay and reliability over a radio link. According to other embodiments of the present disclosure, a PDCP receiving entity maintains a receiving window and a t-Reordering timer is used to assist the PDCP transmitting entity to move the transmitting window. In this way, even if a packet loss occurs over the Xn interface, the transmitting window can be moved and the synchronization between the HFN at the PDCP Tx and the HFN at the PDCP Rx can be maintained.

Other arrangements of the embodiments of the present disclosure as described herein include software programs for performing the steps and operations in the method embodiments as outlined above. More specifically, a computer program product is an embodiment including a computer readable medium having computer program logics coded thereon, which, when executed on a computing device, provides related operations for the above solutions. When executed on at least one processor in a computing system, the computer program logics cause the processor to perform the operations (methods) according to the embodiments of the present disclosure. This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure. A software process operates in combination with computing devices in a set of data communication devices or other entities can also provide the devices according to the present disclosure. The devices according to the present disclosure can be distributed over a plurality of software processes on a plurality of data communication devices, or all software processes running on a set of small application-specific computers, or all software processes running on one single computer.

It can be appreciated that, strictly, the embodiments of the present disclosure can be implemented as software programs in computer devices, software and hardware, or solely software and/or solely circuit.

It should be noted that solutions according to the present disclosure have been described above by a way of example only. However, the present disclosure is not intended to be limited to the above-described steps and element structures.

Instead, when appropriate, the steps and elements structures may be adapted or omitted as required. Thus, some of the steps and elements are not essential for embodying the general inventive concept of the present disclosure. Therefore, essential features of the present disclosure are only limited to those required for embodying the general inventive concept of the present disclosure and are not limited by the above specific examples.

In the foregoing, the present disclosure has been described with reference to preferred embodiments thereof. It should be understood that various modifications, alternations and additions can be made by those skilled in the art without departing from the spirits and scope of the present disclosure. Therefore, the scope of the present disclosure is not limited to the above specific embodiments but shall be defined by the claims as attached.

1. A method in a Packet Data Convergence Protocol (PDCP) transmitting entity for transmitting PDCP Protocol Data Units (PDUs), comprising:
upon receiving an indication message indicating that a PDCP PDU has been successfully transmitted:
moving a transmitting window based on a sequence number of the successfully transmitted PDCP PDU as indicated in the indication message, such that a lower limit of the transmitting window indicates a minimum sequence number among PDCP PDUs that have not been acknowledged to be successfully transmitted;
determining whether there is any PDCP PDU having a sequence number larger than the lower limit of the transmitting window that has been acknowledged to be successfully transmitted; and
starting a timer when there is any PDCP PDU having a sequence number larger than the lower limit of the transmitting window that has been acknowledged to be successfully transmitted.

2. The method of claim 1, further comprising:
moving the transmitting window when the timer expires.

3. The method of claim 2, wherein said moving the transmitting window when the timer expires comprises:
setting the lower limit of the transmitting window to a second smallest sequence number among the PDCP PDUs that have not been acknowledged to be successfully transmitted;
determining whether there is any PDCP PDU having a sequence number larger than the lower limit of the transmitting window that has been acknowledged to be successfully transmitted; and
starting the timer when there is any PDCP PDU having a sequence number larger than the lower limit of the transmitting window that has been acknowledged to be successfully transmitted.

4. The method of claim 3, wherein said starting the timer further comprises:
determining whether the transmitting window has been moved:
starting the timer when the timer has not been started, or restarting the timer when the timer has been started, if the transmitting window has been moved; or
starting the timer when the timer has not been started, if the transmitting window has not been moved.

5. The method of claim 3, wherein the timer that is running is stopped when it is determined that there is no PDCP PDU having a sequence number larger than the lower limit of the transmitting window that has been acknowledged to be successfully transmitted.

6. (canceled)

7. (canceled)

8. The method of claim 1, wherein the indication message contains sequence numbers of all successfully transmitted PDCP PDUs.

9. The method of claim 1, wherein the indication message contains: a minimum sequence number among successfully transmitted PDCP PDUs; and a bitmap and a bitmap length indicator, each bit in the bitmap representing whether its corresponding PDCP PDU has been successfully transmitted, the sequence number of the PDCP PDU corresponding to each bit in the bitmap being a value obtained by adding the minimum sequence number among the successfully transmitted PDCP PDUs and a position of the bit in the bitmap.

10. (canceled)

11. (canceled)

12. (canceled)

13. (canceled)

14. (canceled)

15. A method in a Packet Data Convergence Protocol (PDCP) receiving entity for acknowledging successful reception of PDCP Protocol Data Units (PDUs), comprising:
maintaining a receiving window having a lower limit indicating a minimum sequence number among PDCP PDUs that have not been received;
starting a timer when a PDCP PDU having a sequence number larger than the lower limit of the receiving window and within the receiving window is received;
moving the receiving window and removing the timer when a PDCP PDU corresponding to the lower limit of the receiving window is received; and
moving the receiving window when the timer expires, and transmitting an indication message to a master base station transmitting the PDCP PDU to indicate to the master base station to move the transmitting window, wherein the message contains the minimum sequence number among the PDCP PDUs that have not been received.

16. The method of claim 15, wherein said moving the receiving window when the timer expires comprises:
setting the lower limit of the receiving window to a second smallest sequence number among the PDCP PDUs that have not been received.

17. (canceled)

18. (canceled)

19. (canceled)

20. (canceled)

21. (canceled)

22. (canceled)

23. (canceled)

24. (canceled)

25. A Packet Data Convergence Protocol (PDCP) transmitting entity, comprising:
a timer;
a receiver configured to receive an indication message indicating that a Packet Data Convergence Protocol (PDCP) Protocol Data Unit (PDU) has been successfully transmitted;
a transmitting window moving unit configured to move a transmitting window based on a sequence number of the successfully transmitted PDCP PDU as indicated in the indication message; and
a timer controller configured to determine whether there is any PDCP PDU having a sequence number larger than the lower limit of the transmitting window that has been acknowledged to be successfully transmitted, and start the timer when there is any PDCP PDU having a sequence number larger than the lower limit of the transmitting window that has been acknowledged to be successfully transmitted.

26. The PDCP transmitting entity of claim 25, wherein the transmitting window moving unit is further configured to move the transmitting window when the timer expires.

27. The PDCP transmitting entity of claim 26, wherein the transmitting window moving unit is further configured to set the lower limit of the transmitting window to a second smallest sequence number among the PDCP PDUs that have not been acknowledged to be successfully transmitted, when the timer expires.

28. The PDCP transmitting entity of claim 26, wherein the timer controller is configured to:
determine whether the transmitting window has been moved:
start the timer when the timer has not been started, or restarting the timer when the timer has been started, if the transmitting window has been moved; or
start the timer when the timer has not been started, if the transmitting window has not been moved.

29. The PDCP transmitting entity of claim 26, wherein the timer controller is configured to remove the timer that is running when it is determined that there is no PDCP PDU having a sequence number larger than the lower limit of the transmitting window that has been acknowledged to be successfully transmitted.

30. The PDCP transmitting entity of claim 26, wherein the timer controller is configured to determine whether a PDCP PDU corresponding to the lower limit of the transmitting window has been transmitted to a secondary base station;
wherein, if so, the timer is started; or otherwise no operation is applied to the timer.

31. The PDCP transmitting entity of claim 26, wherein the timer has an expiration value that is set based on a t-Reordering timer of a PDCP receiving entity that receives PDCP PDUs from the PDCP transmitting entity.

32. The PDCP transmitting entity of claim 26, wherein the indication message contains sequence numbers of all successfully transmitted PDCP PDUs.

33. The PDCP transmitting entity of claim 26, wherein the indication message contains: a minimum sequence number among successfully transmitted PDCP PDUs; and a bitmap and a bitmap length indicator, each bit in the bitmap representing whether its corresponding PDCP PDU has been successfully transmitted, the sequence number of the PDCP PDU corresponding to each bit in the bitmap being a value obtained by adding the minimum sequence number among the successfully transmitted PDCP PDUs and a position of the bit in the bitmap.

34. (canceled)

35. A User Equipment (UE), comprising:
a memory configured to maintain a receiving window having a lower limit indicating a minimum sequence number among Packet Data Convergence Protocol (PDCP) Protocol Data Units (PDUs) that have not been received;
a receiver configured to receive at least one PDCP PDU;
a timer;
a timer controller configured to start the timer when a PDCP PDU having a sequence number larger than the lower limit of the receiving window and within the receiving window is received by the receiver, and remove the timer when a PDCP PDU corresponding to the lower limit of the receiving window is received by the receiver;
a receiving window moving unit configured to move the receiving window when a PDCP PDU corresponding to the lower limit of the receiving window is received by the receiver or when the timer expires; and
a transmitter configured to transmit an indication message to a master base station from which the PDCP PDU is received to indicate to the master base station to move the transmitting window when the timer expires, wherein the message contains the minimum sequence number among the at least one PDCP PDU that have not been received.

36. The UE of claim 35, wherein the receiving window moving unit is configured to set the lower limit of the receiving window to a second smallest sequence number among the PDCP PDUs that have not been received, when the timer expires.

37. (canceled)

38. (canceled)

39. (canceled)

40. (canceled)

41. (canceled)

42. (canceled)
